(19) United States
(12) Patent Application Publication
(10) Pub. No.: US 2015/0372522 A1
(43) Pub. Date: Dec. 24, 2015

(54) Rechargeable battery with multi function generator and lantern

(71) Applicant: Sung H. Park, Vancouver, WA (US)

(72) Inventor: Sung H. Park, Vancouver, WA (US)

(21) Appl. No.: 14/312,521

(22) Filed: Jun. 23, 2014

(51) Int. Cl. H02J 7/00; H02J 7/02

(52) U.S. Cl. CPC H02J 7/0068; H02J 7/02

(57) ABSTRACT

The generator lantern is designed to work with a burner or rechargeable battery to generate electricity, operate small devices, light and heat.

The rechargeable battery with a multi function generator and lantern is operated with a burner or a battery. The embodiment consists of rechargeable batteries, multi-function switches, light bulbs and output jacks to operate electronic devices and a lantern. The embodiment can operate at full capacity using a fully charged battery alone.

### SPECEFICATION

“C Gerhard Span, Waters (AT); Martin Wagner, Bad Mitterndorf (AT) Pub. No.: US 2013/0312803 A1 would be properly limited and under current statutes, legally sufficient notices of copyright and mask work, respectively.

The rechargeable battery with multi-function generator and lantern is a new and useful combination of the generator and the lantern. The dimensions are 7 inches×5.25 inches wide and 5.8 inches tall. It weighs 4 lbs and 3 oz.

To begin operating the rechargeable battery with multi-function generator and lantern, turn on and ignite the burner for approximately 1 minute. Once the burner has been lit, the cooling fan will begin to turn. After about 1 to 2 minutes, enough electricity is generated to illuminate the built in lantern and to operate a small electronic device. An additional auxiliary component to the embodiment includes a USB jack cable for connection to a cell phone, tablet pc or other small electronic devices.

One may use a camping burner or backpack burner which is light weight, compact and convenient as heat source. Alternatively, another heat source may be employed. For example, it can be operated with any fuel burning heating device, burners, and open flames, the embodiment works with any heating device as shown in FIG. 3A-1,3A-2, FIG. 3B-1, 3B-2, FIG. 3C-1,3C-2 and FIG. 3D-1, 3D-2.

The embodiment contains lithium-ion polymer battery. The lithium-ion polymer battery can be charged using the generator or with a power source supplied through a standard household outlet (120V AC). When saved battery power and the generator are used together, it can generate 10 to 30 watts of power, available for operating a higher wattage device until the battery runs out of stored charge. When the fully charged battery is used alone, 10 watts of power can be produced. This is enough power to charge a cell phone and fully light the built in lantern.

The embodiment contains nine LED high efficiency lights which can be varied for brightness. In FIG. 4A.c all nine LED lights will operate on battery power for 2 hours. In FIG. 4A.b one LED light will operate for 15 hours. In FIG. 4A.a a low light LED light will operate for 100 hours. In FIG. 1, heat is also generated when the generator is operated by burner, and directed outward of the embodiment. The output voltage is stored in a rechargeable battery as in FIG. 2, 9 which is the energy source to the electrically powered devices. Any light weight lithium ion polymer battery is designated as the storage battery. However, an unlimited number of rechargeable battery types may be employed for this purpose. For example, the storage battery may be a, lead-acid, alkaline, nickel iron, nickel cadmium, nickel hydrogen, nickel metal hydride, nickel zinc, lithium air organic, lithium cobalt oxide, lithium ion, lithium iron phosphate, lithium sulfur, lithium titan ate, sodium ion, thin film lithium, zinc bromide, vanadium red ox, sodium sulfur, molten salt, silver oxide, quantum battery, oxide semiconductor.

The embodiment operates on the electricity generated by the generator and the rechargeable battery. The embodiment is the supply of energy to the electrically powered devices when, for example camping, fishing or during emergencies when the normal energy source is out of service. Whether the failure of powered devices is due to current or predicted weather parameters, military parameters or homeland security parameters, embodiment will act as a power source useful during times when there is no electricity.

The switches FIG. 2, 14 Circuit Board Control panel may be formed of aluminum enclosure for housing, the structure of the multi function switches is described below with reference to FIG. 3A-1, 3A-2, FIG. 3B-1,3B-2, FIG. 3C -1, 3C-2, FIG. 3D-1, 3D-2, FIG. 4A and FIG. 4B. A structure for operating a multi-function switch assembly includes a circuit board between front and back casing coupled together to line each other. They position up, center and down for three way control. Multi function switches are mounted on the middle of Circuit Board Control panel FIG. 2, 14 When the embodiment is operated with gas burner FIG. 3A-1, 3A-2, FIG. 3B-1, 3B-2, FIG. 3C-1, 3C-2, FIG. 3D-1, 3D-2, the embodiment generates 10 watts of energy. The multi-function switches functions control brightness of light, dimmer light for storing energy and to illuminate switches, operate devices, charge external battery, charge automatically internal embodiment's battery, generate extra wattage to operate higher wattage device.

The embodiment is an arrangement comprising of the Thermo Generator having a hot side which discharges heat to a heat sink and electrical terminals for outputting electrical energy with an output voltage and an electric circuit with a maximum permissible input voltage. The inputs which are connected to the electrical terminals of the Thermo Generator having a hot side which absorbs heat from a heat source, a cold side which discharges heat to a heat sink, and electrical terminals for outputting electrical energy with an output voltage. As illustrated in FIG. 3 A-1, 3A-2, when the switch 1(18) is in the down position, and the switch 2 (22) is in the center position the Dimmer three (17, 21, 30) LEDs are ON, the lights (17, 21) illuminate the switches. When the switch 1 (18) is in the down position, and the switch 2 (22) is in the down position the (30) bright LED light is ON. When the switch 1 (18) is in the down position, and the switch 2 (22) is in the UP position seven (10, 11, 12, 15, 19, 24, 30) bright LEDs are ON. In FIG. 3B-1, 3B-2, when the Switch 1 (18) is in the center position, the output Jack 2 (16) can charge the external rechargeable battery. In FIG. 3C-1,3C-2, when the switch 1(18) is in the down position, the internal battery will charge automatically. In FIG. 3D-1,3D-2, when switch 1 (18) is in the up position and the switch 2(22) is in the center position, the device generates extra wattage 10 W-30 W, because the charged battery in the device and thermo generator are working together. The output Jack 1 (23) can be operated at that higher wattage device.

When the embodiment operates by the internal charged battery FIG. 4A, and FIG. 4B. FIG. 4A the switch 1 (18) is in the up position, when the switch 2 (22) is in the center position three Dimmers (17, 30, 21) low bright LEDs are ON, the two (17, 21) dimmer lights illuminate the switches. When the switch 1 (18) is in the down position, the switch 2 (22) is in the down position one of bright light (30) LED is ON. When the switch 1 (18) is in the down position, and the switch 2 (22) is in the up position high bright seven (10, 11, 12, 15, 19, 24, 30) Bright LEDs are ON. FIG. 4B, When the switch 1(18) is down position Output Jack 2 (16) there are 12V OUT. When the switch 1 (18) is in the down position, an Output Jack 2 (16), the embodiment can operate a small device or charge an internal embodiment battery.

There is provided an electricity storage system which comprises an electricity storage device which controls charging from a power supply and discharging from the electricity storage device to an external load, and an electricity storage device reception functions which is provided the charge and discharge switches according to an instruction of control switches.

### BACKGROUND OF THE INVENTION

The present invention is in the technical field of lantern. More particularly, the present invention is in the technical field of generator lantern. More particularly, the present invention is in the technical field of thermo generator lantern.

### BRIEF SUMMARY OF THE INVENTION

Rechargeable battery with multi function generator and lantern is for situations in which electricity is not readily available such as in camping, fishing and natural disaster situations. The embodiment is designed to work with a burner or rechargeable battery to generate electricity, light, and heat. The power produced can be used to light the multiple LED light lantern. The lantern has varied levels of brightness. The power can be used to operate electronic devices via output jacks or a USB port. When the embodiment is operated by burner will work as a heater and directed outward on two sides of the embodiment. The embodiment's measurements are 7 inch by 5.25 inches, and 5.8 inches high and, weights on 4 pounds 3 ounces. The embodiment contains multiple LED lights which can be varied for brightness. The embodiment has multiple switches. Those switches are three way, they control many different functions. The embodiment has multiple jacks, and can charge the internal battery, an external battery, and operate devices. The embodiment will operate with any burners, to provide convenience and enhanced security in the case of a disaster. The embodiment can be used for situations in which electricity is not readily available such as in camping, fishing and natural disaster. The embodiment is light weight, compact and convenient.

The embodiment contains a rechargeable lithium ion polymer battery. The battery can be charged via the generator, and with power supplied through a standard household outlet 120V AC. The saved battery power and the generator can be used together to operate higher power devices. When the embodiment is fully charged the battery can be operated alone, 10 watts of power is available. This is enough power to charge cell phones and fully operate the embodiment. In times of emergency when burner or battery power is not available the embodiment can operate with a small campfire. An embodiment has multiple functions and works as a lantern and generator when powered by the burner or rechargeable lithium ion polymer battery and can be used for camping, fishing, and natural disaster.

### BRIEF DESCRIPTION OF DRAWINGS

FIG. 1-A, FIG. 1-B, FIG. 1-C, FIG. 1-D shows full view of all side of the Embodiment

FIG. 2 shows Exploded View of the Embodiment with Parts list

FIG. 3A-1,3A-2, 3B-1,3B-2, 3C-1,3C-2, 3D-1,3D-2 shows Embodiment with Burner

FIG. 4A, 4B shows Embodiment with Internal Battery

FIG. 5 shows Circuit board Control panel

FIG. 6 shows Full View of the Embodiment

FIG. 7 shows different side full view of the embodiment

FIG. 8 shows full view of the embodiment with the battery case

FIG. 9 shows Hot side Bottom of Base Plate

FIG. 10 shows full view of switch side the embodiment

FIG. 11 shows Wiring

FIG. 12 shows Top of the embodiment

FIG. 13 shows the Fan and Fan cover

FIG. 14 shows hot side Top of Base Plat

FIG. 16 shows Bracket set of 4

FIG. 17 shows Battery Case

FIG. 18 shows Circuit Board Control panel

FIG. 22 shows Heat sink cooling side

FIG. 24 shows Full view of the embodiment

### DETAILED DESCRIPTION OF THE INVENTION

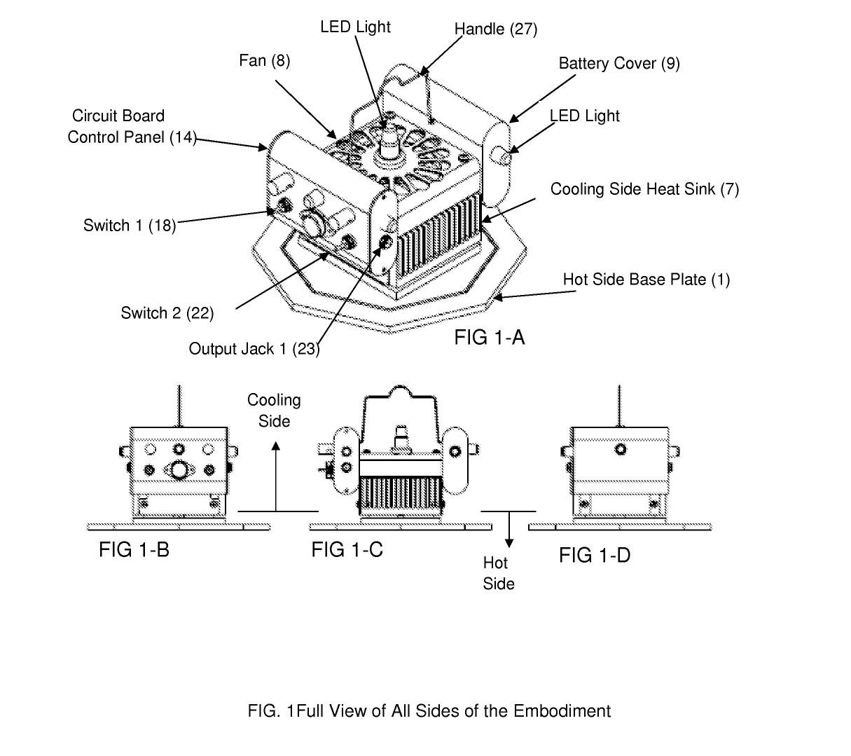

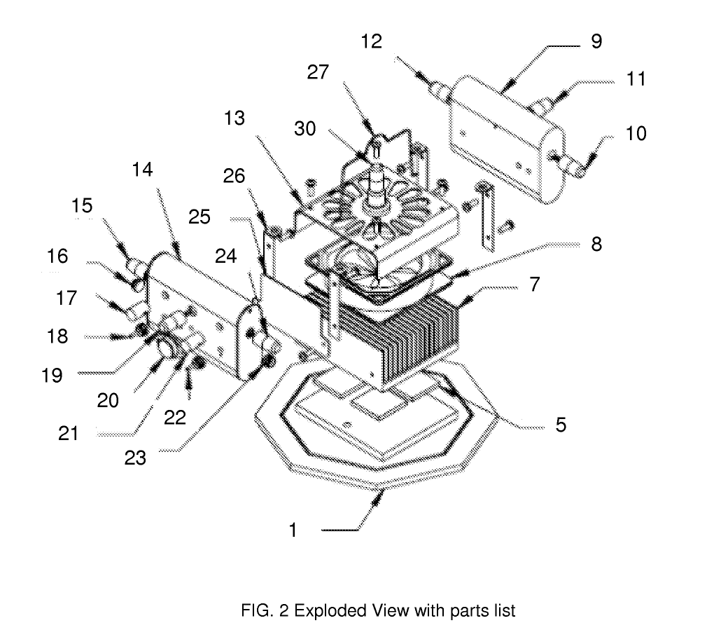

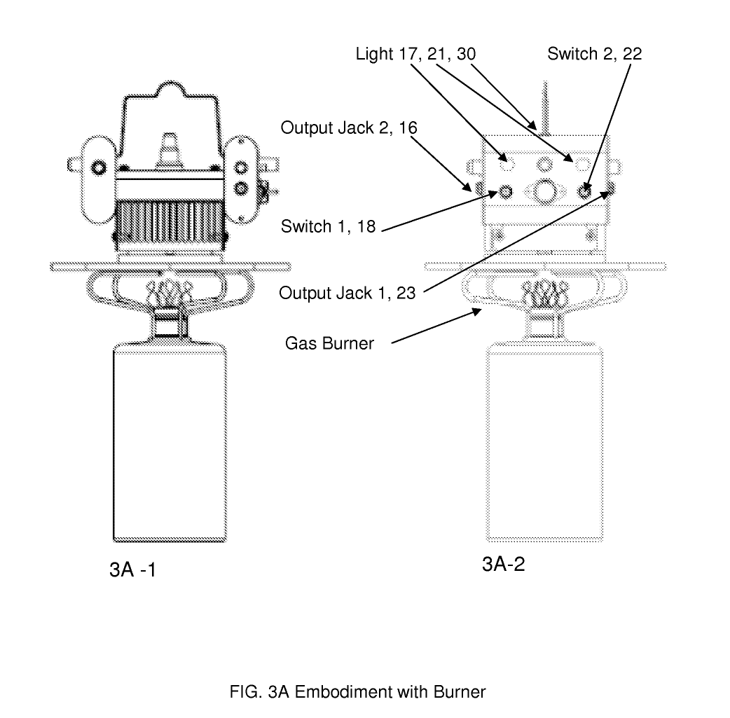

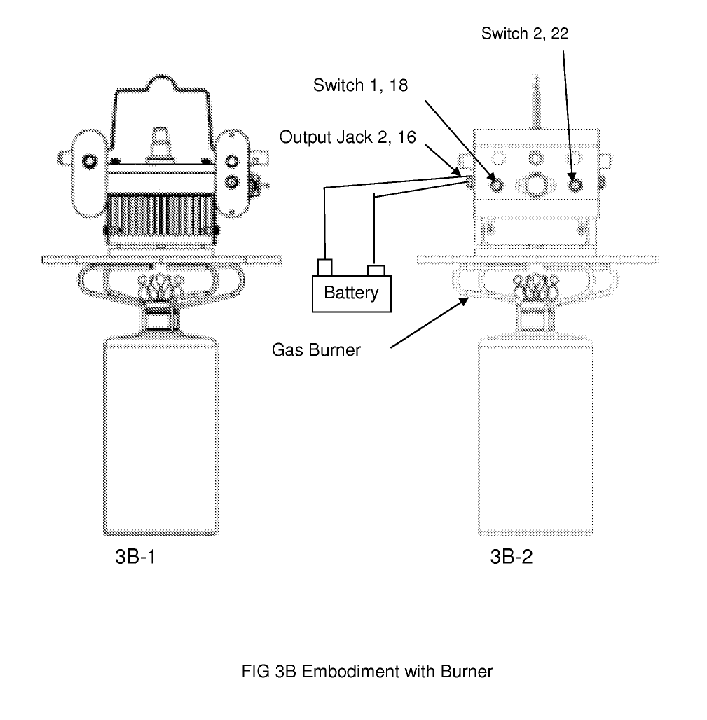

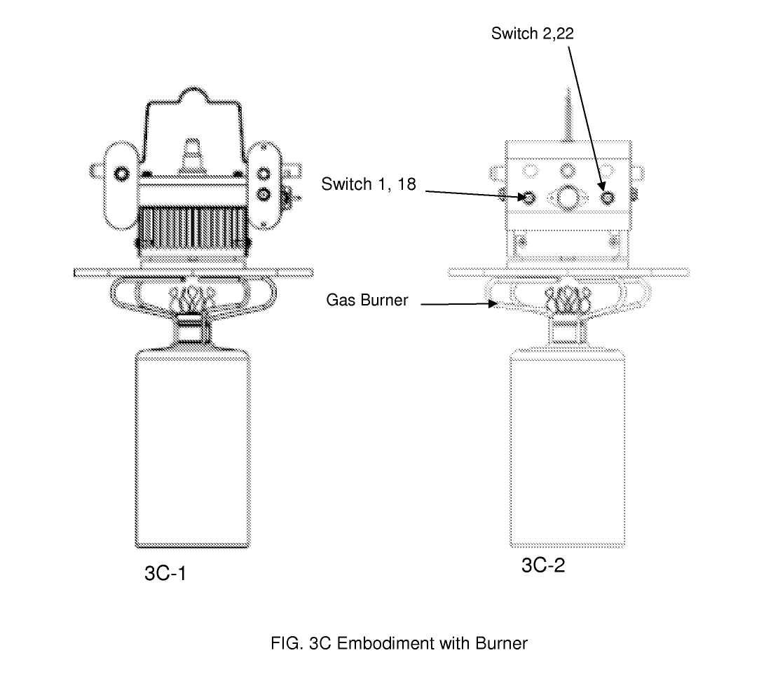

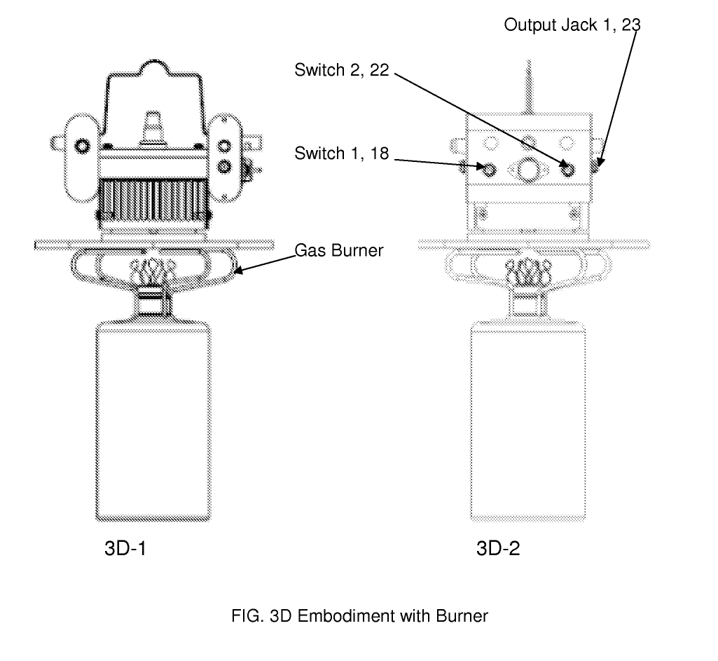

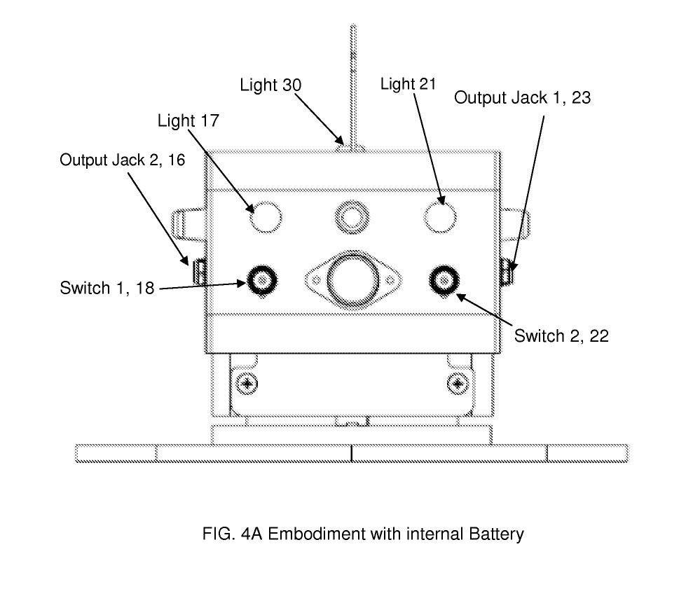

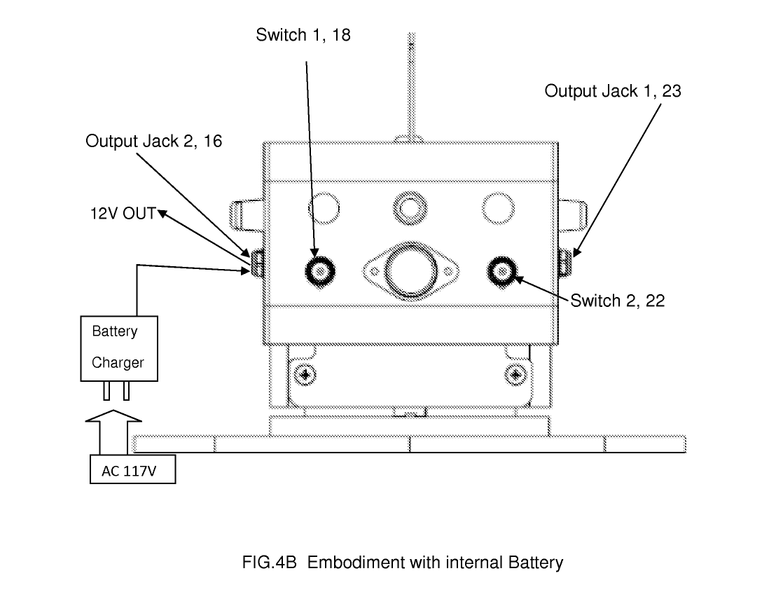

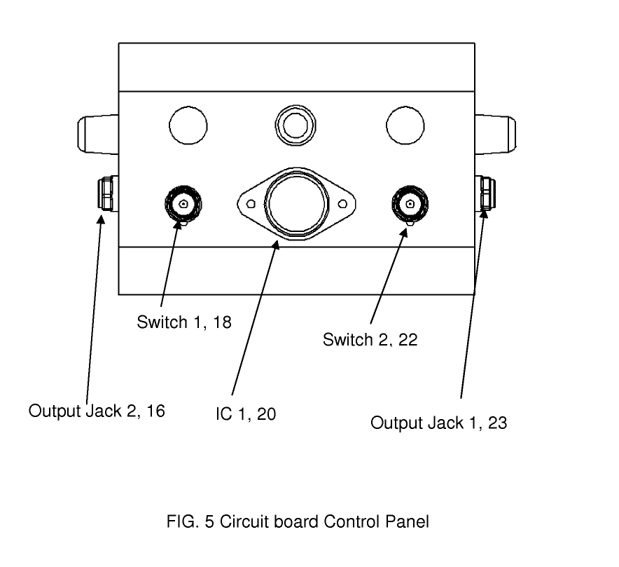

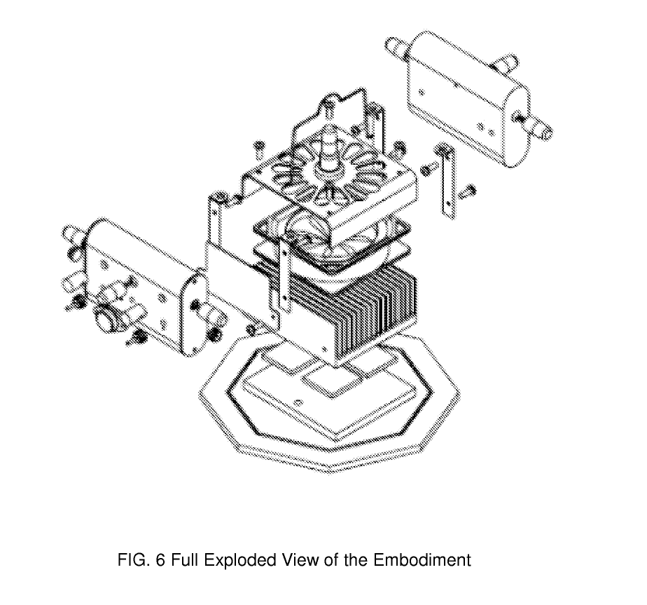

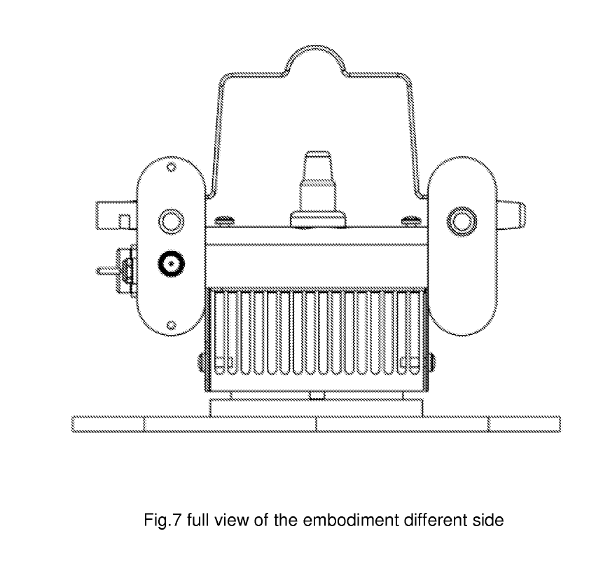

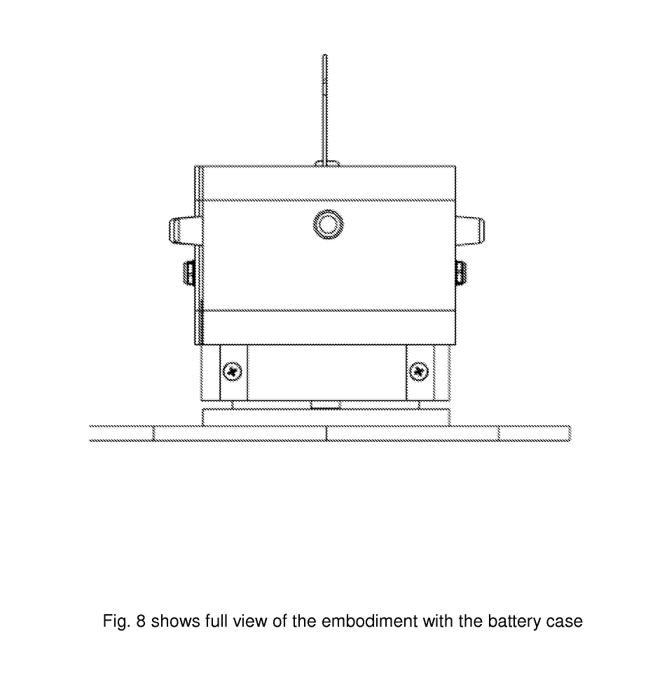

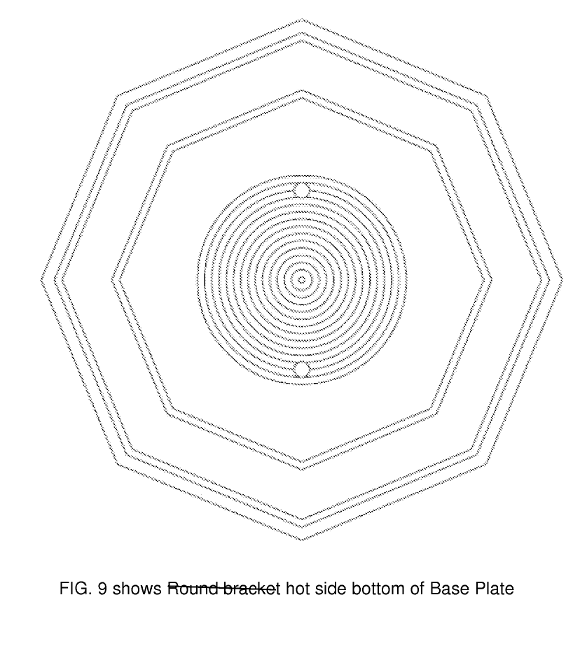

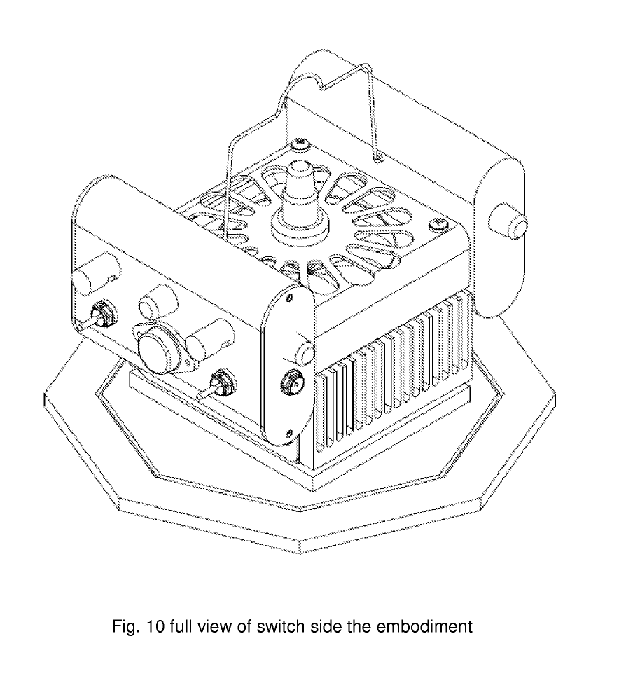

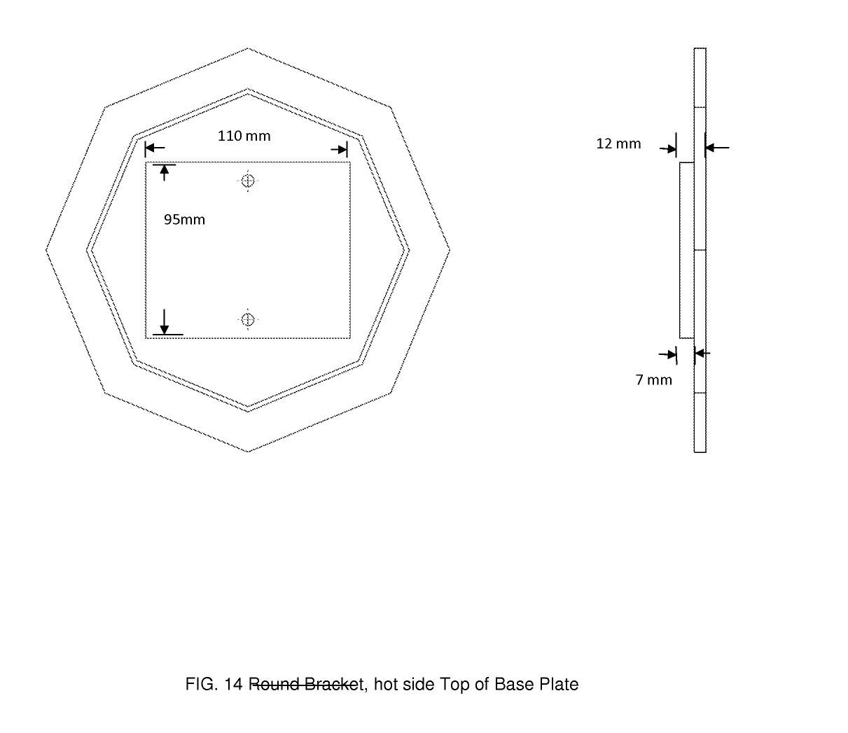

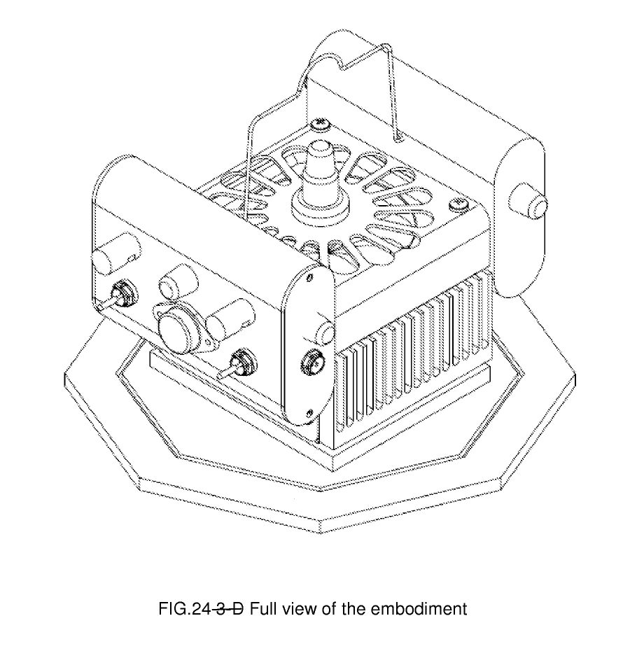

This references the invention, providing more detail: in FIG. 1 and FIG. 24. The rechargeable battery with multi function generator and lantern is 7 inches by 5.25 inches width and 5.8 inches tall. It weighs 4 lb 3 oz contains 9 LED lights, 2 output jacks, 2 switches, a lithium-ion polymer battery and circuit board control panel and battery case. Referring now to the embodiment in more detail, FIG. 14, and FIG. 9, 1 show the Base Plate hot side, the Base plate is the base of the embodiment. It is Octagonal 200 mm in diameter, and 7 mm thick, the top side of the base plate FIG. 14,1 has octagonal grooves, 20 mm from the edge of the base plate, 3 mm deep and 3 mm thick, on top side with rectangular platform is 95 mm by 110 mm, and 12mm thick, two screw holes which are 82 mm a part. the Bottom of the Base plate FIG. 9,1 has octagonal grooves, 1st groove is 5 mm from the edge of base plate, and 2nd groove is 30 mm from the edge of base pate, and 8 consecutive grooves spaced 3 mm apart and 3 mm deep.

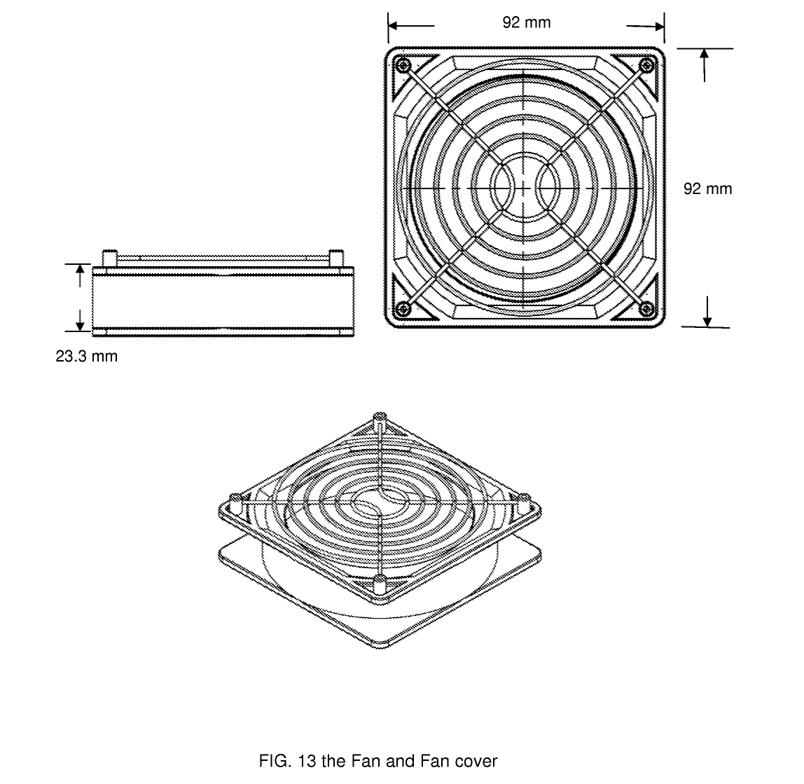

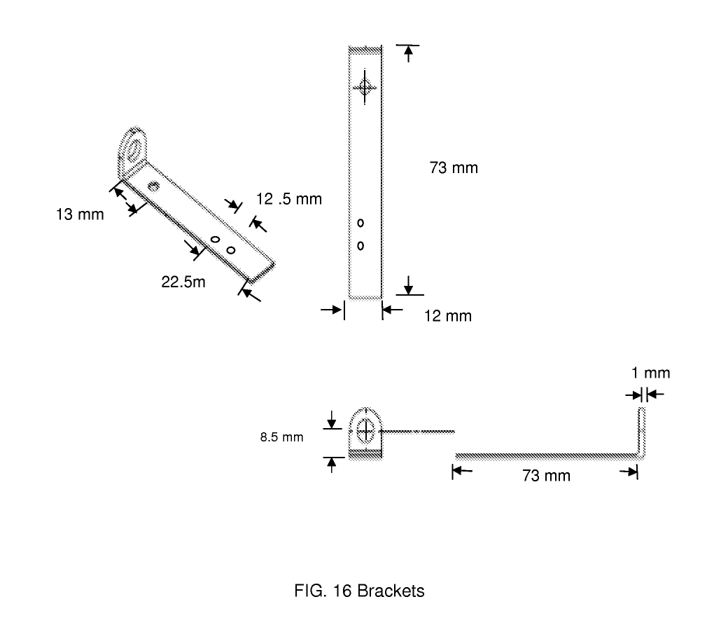

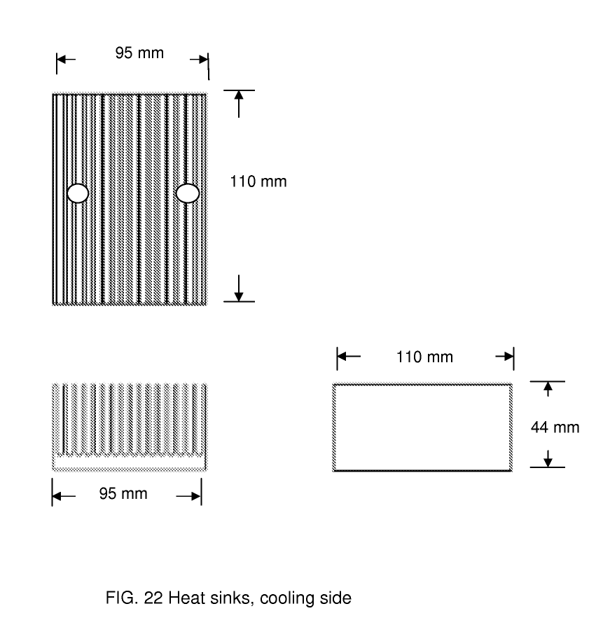

The Base Plate hot side FIG. 9, FIG. 14, 1 and the cold side FIG. 22, 7 measuring 110 mm by 95 mm are two screw holes which are 82 mm apart, located here are 4 peltiers, parts list 5, each measuring 35 mm by 35 mm 3.7 mm thick, the Base plate FIG. 9,1 and the cold side FIGS. 22,7 and 4 peltiers, held by two ceramic heat resistant washers and a bolt. At the top of the cooling side heat sinks FIG. 22, 7 is a fan and the fan cover FIG. 13, 8,13, they are 92 mm by 92 mm and 23.3 mm thick. This works to cool the heat sinks cooling side FIG. 22, 7. Holding the fan to the cold sink are four cover brackets, two each side, FIG. 16, 26. The bracket is 73 mm long, with a flange of 8.5 mm, the screw holes are 1^{st} 13 mm from flange, 2^{nd} placed 22.5 mm from the other end of the bracket, and the 3^{rd} placed 12.5 mm from the 2nd toward the flat end of the bracket.

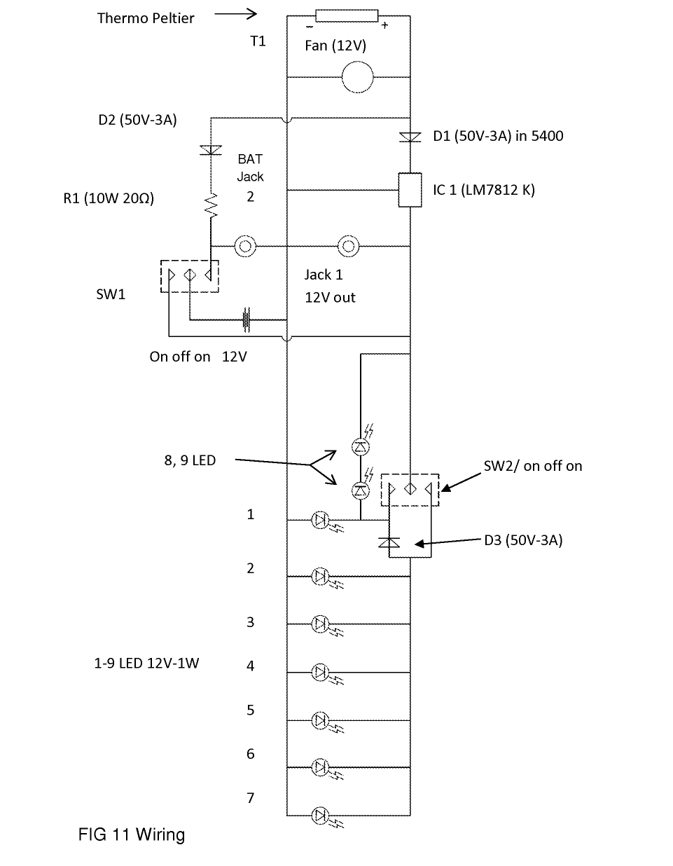

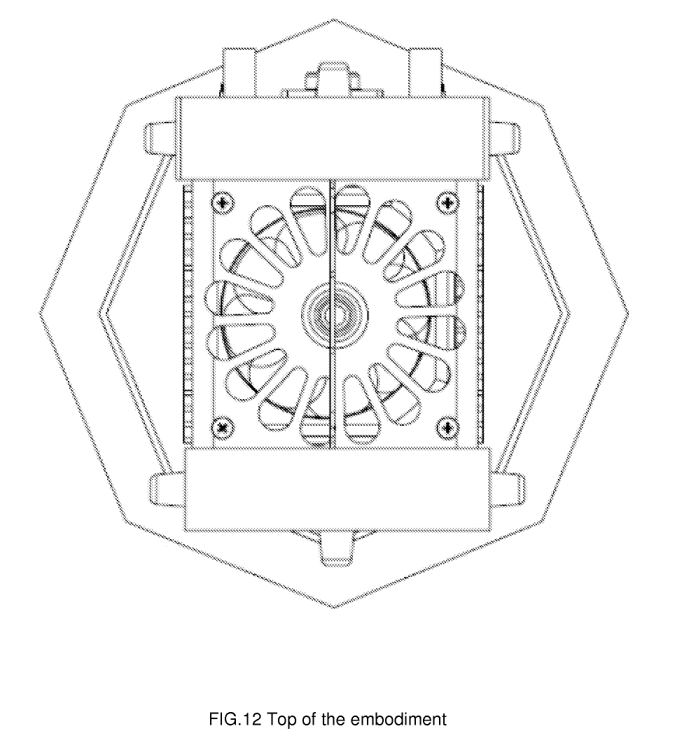

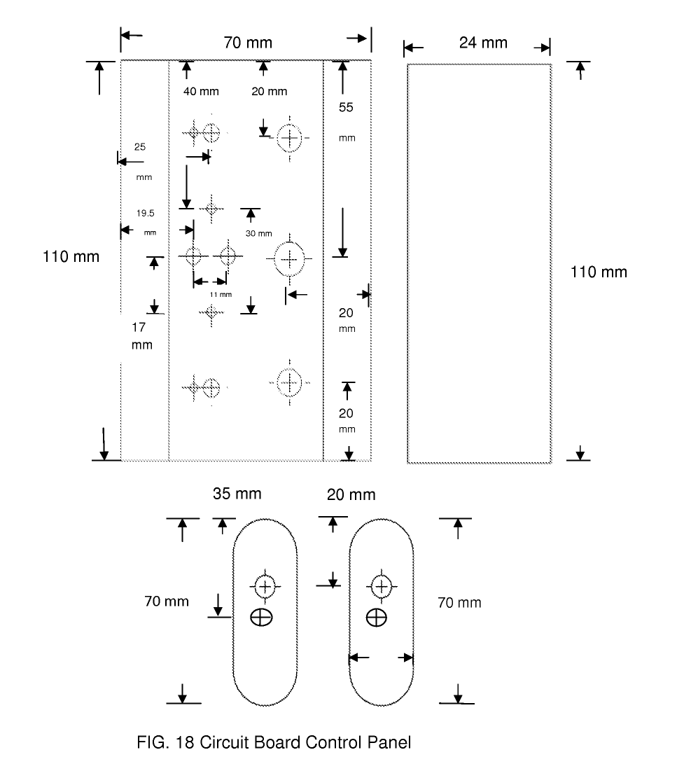

There is a circuit board control panel FIG. 18, 14 outer dimensions is 24 mm height by 63 mm width by 110 mm length, and inner dimensions are 21 mm height by 61 mm width by 110 mm length. It is of heavy gauge extruded aluminum construction with a professional sandblast matte anodized finish. It is located between the fan front and back casing coupled together in line with each other. In the circuit board control panel is electronic Wiring FIG. 11, for 9 of LED lights these are connector type G4, luminous flux 70-90 LM, with output power 1 w, input voltage 12V, made of aluminum, dimensions: 3.0 cm by 1.2 cm, low power consumption; Also for 2 output jacks: they are jack socket female panel mount connectors, 5.5 mm by 2. 1mm DC power, for charging the battery operating device, and charging the embodiment. Also for switches which are mini toggle switches: on-off-on SPDT (with center off), current rating 6A @125 Vac, 3A @250 Vac, length 12.5 mm, width 7.5 mm height 9 mm tag 3.75 mm mounting hole 4.75 mm diameter overall height 32 mm, they position up, center and down for three way control. They are mounted 72 mm on center of Circuit Board. Also for the voltage regulator IC; LM 7812K To-3, Vo=12v+−5% IA Pd=15 W. Also for the cement resistor: power 10 W, resistance 20 ohm, tolerance +−5% (J), body size length 48 by width 10 by height 10 mm, lead diameter 0.8 mm weight 5.8 g, this prevents over charging the battery. Also 3 Diodes IN 5400 3 Amp 50 V.

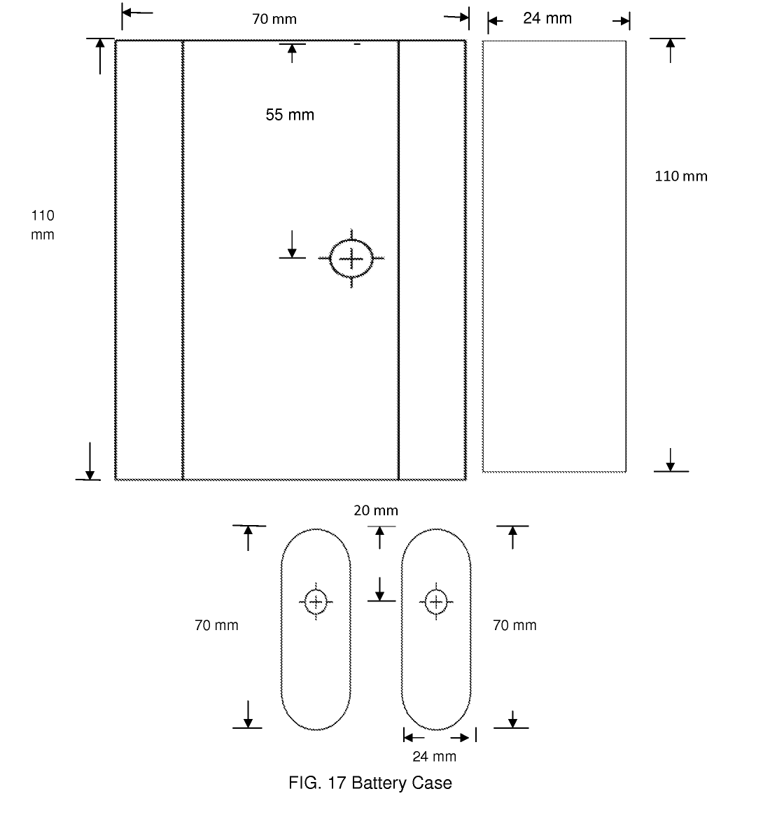

In the battery case FIG. 17, 9 outer dimensions is 24 mm height by 6 3mm width by 110 mm length, and inner dimensions are 21 mm height by 61 mm width by 110 mm length. It is heavy gauge extruded aluminum construction with a professional sandblast matte anodized finish. It is located between the fan front and back casing coupled together in line with each other. contain a light weight compact lithium ion polymer 12V DC battery with power capacity 1800 mAh (total amount of energy a battery can store at a time). The input voltage is 12.6V, and output voltage 12.6-10.8V, the dimensions are: 6.6 cm height, 3.7 cm length, 2 cm width.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. Rechargeable battery with multi function combination of a generator and a lantern comprising of: a circuit board control panel; a battery case; light bulbs; switches; and output jacks which are mounted on the embodiment.

2. the invention of claim 1 wherein said battery case is mounted on top of said, the battery housing is located in line with the circuit board control panel, these are mounted on either side of the cooling side heat sink.

3. the invention of claim 1 wherein said contains rechargeable battery is in claim 2, the fully charge battery can operate alone, operate a built in lantern, charge small devices, and charge an external battery, the rechargeable battery can be charged by a generator or a power supply.

4. the invention of claim 1 wherein said operates with burners, with any heating device, fuel burning device, burners, or open flames.

5. the invention of claim 1 wherein said mounted a circuit board control panel, that is wiring of light bulbs, switches and output jacks, controls the electrical assembly.

6. the invention of claim 1 wherein said mounted multiple light bulbs are mounted on claim 2, claim 5 and top of said for varied levels of brightness, and illuminate said switches.

7. the invention of claim 1 wherein said a output jacks are mounted on claim 5 said for charging devices, charging an external battery, charging an internal battery and operating devices.

8. the invention of claim 1 wherein said mounted a multi function switches, assembled on claim 5 on said, a switches' functions are; the control of varied levels of brightness of lights, dimmer light to save energy and illuminate switches, operate devices, charge an external battery, automatically charge the internal said battery, operate a higher wattage device.

9. the invention of claim 1 wherein said when saved battery power claim 3 and generator are used together, said higher watts of power are available for said to operate higher wattage devices.

10. the invention of claim 1 further comprising said heat is generated when the said is operated by burner, and is directed outward of said.
